(19) United States
(12) Patent Application Publication
(10) Pub. No.: US 2007/0177377 A1
(43) Pub. Date: Aug. 2, 2007

(54) Rechargeable flashlight

(76) Inventors: Xiang Yang Ding, Shen Zhen (CN); Jin Wang, Kennesaw, GA (US); Bernard D. Goldfine, Kennesaw, GA (US); Thomas A. Disco, Acworth, GA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/701,015

(22) Filed: Jan. 31, 2007

Related U.S. Application Data
(60) Provisional application No. 60/764,742, filed on Feb. 2, 2006.

(51) Int. Cl. F21L 4/00

(52) U.S. Cl. 362/183

(57) ABSTRACT

A flashlight includes a dynamo connected with a retractable handle. At least one rechargeable battery is connected to the dynamo. Many light emitting diodes (LEDs) are connected to the rechargeable battery. A first switch is connected to the rechargeable battery.

This application claims the benefit of U.S. Provisional Patent Application Ser. No. 60/764,742, filed on Feb. 2, 2006, entitled “RECHARGEABLE FLASHLIGHT,” which is hereby incorporated by reference in its entirety herein.

### BACKGROUND

1. Field of Invention

This invention is directed generally to flashlights, and more particularly to a miniature flashlight using a light emitting diode (“LED”) as a light source that can be and historically has been useful for all law enforcement personnel, military personnel and civilians alike.

Conventional general purposes of flashlights are well known in prior art and have often been used by law enforcement personnel in execution of their duties, by Armed Services Members in defense of our country and by civilians in both everyday and emergency situations. Flashlights are used for a wide variety of purposes. For example, they are often used during traffic stops to illuminate the interior of a stopped vehicle, or to complete a report in the dark. Flashlights are also used to facilitate searches of poorly lit areas and may be used to illuminate dark alleys or stairwells. Flashlights are also used to check or adjust equipment when positioned in a dark area. Flashlights can be used to send coded signals from one individual to another. Generally, small incandescent light bulbs and LED flashlights are not dependable when needed.

However the size and weight of conventional flashlights add to the inconvenience and reduces the mobility of law enforcement personnel. Sometimes the flashlight is purposeful or inadvertently left behind. Often when needed after a period of time when the traditional flashlight is not in use, the batteries become dead causing an extreme inconvenience during a possible dangerous time for the law enforcement officials. This presents a problem when the need for a flashlight arises. In addition to the use of flashlights by law enforcement personnel, men and women in the Armed Forces face similar dangerous situations and are dependent on the need for light when ever a flashlight is called upon.

Civilians also use flashlights for a number of different reasons. Besides the traditional home use of flashlights, smaller flashlights are often used in today's society for various security purposes. For example, when going to one's car late in the evening, it is not uncommon for an individual, especially a female, to carry a small flashlight in her pocketbook or on her possession. She can use the flashlight to assist in a variety of ways to satisfy her desire to remain safe and free from harm while entering her car or her place of residence. Even small conventional flashlights are generally cumbersome and become extremely inconvenient to use when called upon and the batteries have expired in the most inopportune times.

Thus, there is a need for a compact, lightweight flashlight that may easily be carried on the person of a law enforcement officer, Armed Services personnel or a civilian. The convenience of having a light weight flashlight, which is always ready when you are, which replaces all flashlight technology since replacement batteries or bulbs are never needed and a flashlight that is easy to operate through the ease and convenience of a pull of the trigger has now found a great need in our society.

2. Description of the Related Art

Although not having been proved useful to law enforcement personnel, there exist in the prior art a small flashlight known as the Photon Micro-Light®. The Photon Micro-Light® consists of two flat, circular 3-volt batteries, a light emitting diode (“LED”) and an outer shell that encloses the batteries and leads of the LED. The Photon Micro-Light® uses a slide switch or pressure switch that activates the light by moving the leads of the LED into direct engagement with the batteries. The outer shell consists of two hard plastic parts opposite either side of the batteries and may be held together with four threaded screws.

The Photon Micro-Light®, however, has a number of disadvantages. The Photon Micro-Light® lacks durability required for a miniature flashlight. It lacks the internal structure for protecting and securing the batteries and LED. Only the hard plastic shell protects the internal components of the flashlight. Thus, little protection is provided for the internal components of the flashlight and it may be adversely affected when subject to shock.

The Photon Micro-Light® operates by using either a slide switch or pressure switch, which upon activation brings both leads of the LED into direct engagement with the batteries. This operation results in increased fatigue on the leads of the flashlight and undesirable wear that affects the reliability of the switch. Moreover, because of its external shape and hard plastic outer shell construction, the Photon Micro-Light® is not suitable for receiving markings or engravings on the outer surface thereof, cannot have a medallion installed thereon, have a die struck panel, or disclose using a translucent housing. The construction of the Micro Light is not well suited or adapted to allow for color coding or desired markings or engravings.

### SUMMARY

The subject invention is specifically directed to a small, compact LED flashlight useful for law enforcement personnel, Armed Services Members and civilians. One embodiment of the invention includes an LED flashlight wherein the LED has first and second leads extending therefrom; a power source; a power source frame enclosing at least a portion of the power source; a power source frame housing containing the power source frame, light source and power source; and a key ring extension extending from the power source frame.

The power source frame is non-conductive and has a cavity adopted to house the power source. The power source frame can also have a receptacle for receiving and housing a connector end of the light source. The power source frame therefore serves as a fitted compartment for holding in place and protecting the various internal components of the flashlight. The power source frame provides significant protection to the power source and the light source and serves to cushion these elements from the adverse affects of any shock the flashlight might receive from normal wear and tear or inadvertent mishaps. The power source frame housing encases the power source frame, and provides further protection to the internal components of the flashlight, in addition to that provided by the power source frame. The power source frame housing thus serves to provide an additional level of protection to the light source and the power source and enhances the durability of the flashlight.

Another embodiment of the invention can be an LED flashlight wherein the LED has first and second leads extending therefrom; a power source having a first side and second side, the second side being opposite to the first side; a housing enclosing the leads of the LED and power source, wherein the housing is comprised of plastic material and a switch operable to close a circuit including the LED and power source.

Still a further embodiment of the invention includes a spring loaded switch located adjacent to the power source which releases a retractable handle from one side of the cover, this handle, when pumped activates a dynamo through a series of gears which recharges the power source. With the power source recharged the handle is retracted into the cover and locked into a closed position.

Further expounding on this revolutionary technology for flashlights, near the on/off slide switch, which controls the emitting of light from the LED's is another slide switch, which activates the handle used for recharging. This slide switch is unique to the flashlight industry for upon release the retractable lever allows recharging of a battery. The slide switch, which operates the retractable lever, is similar to the slide switch, which activates the on/off switch on the flashlight. Both slide switches, are activated by applying a horizontal pressure to move the switch forward or backward.

The spring loaded retractable handle, when released by the slide switch and hand pumped three or four times immediately activates a series of gears to drive a dynamo. The three or four pumps on the retractable handle causes the dynamo to spin at or slightly 1650 RPM producing 3.0 dc volts and adequate current that recharges the Ni-MH, Nickel Cadmium, or Lithium Rechargeable battery, thereby creating additional operating time. One-handed charging with the squeeze of the retractable lever, allows for users to operate the light with one hand free for other tasks (e.g., manipulating others objects, holding a stair railing, opening a car door, turning a page in a book, etc).

Another unique feature is that the squeezing of the spring loaded, retractable lever allows the user to rest between pumping actions (while the lever springs back into open position), thereby reducing the likelihood of operator fatigue. This retractable hand generator when combined with the rechargeable NiMH, Nickel-Cadmium, or Lithium technology allows for ease of operation during recharging. Finally, another unique and distinguishing feature of this invention is that the user is able to actually use the flashlight during the recharging process, and as aforementioned, have one hand free throughout the entire process.

This invention allows a user to meet both of these conditions simultaneously when the light emitted from the unit is in a state of failure: (1) allows recharging with squeezing of the spring-loaded retractable handle (which is obviously not possible with non-rechargeable units), and continued use of the unit because it is producing light on whatever the user wishes to aim focus upon with the flashlight allowing to be aimed in a stable manner and; (2) to conduct this recharging process with the use of only one hand. Consequently, another unique aspect of this invention is that it is ideal during emergency outages because users are never in the dark and can aim and focus the LEDS even during the recharging stage with one hand. In certain emergencies, having a hand free (even during recharging) is important; an example of this would be the application for a miner who might be trapped in a collapsed mine.

It is also important to note that the retractable, spring-loaded recharging lever (when not in use, i.e., in the retrained position) stores conveniently within the housing of the flashlight, which is unique in the flashlight industry. The retractable handle guarantees that the flashlight is not intrusive in size allowing for more efficient portability. When retracted, this handle used for recharging the internal battery in the flashlight allows for the flashlight to remain small in size and easy to transport. In summary, the spring-loaded slide switch, which can lock in place when the owner desires to hide the handle or can be released, serving as the means to recharge the battery, is the first spring loaded, retractable handle in the flashlight industry.

Furthermore, when the spring loaded handle is in the restrained position it provides additional protection to the multiple gear train assembly and the dynamo. Finally, there is an obvious advantage to this mechanism, in terms of portability and storage, i.e., there are no protruding or bulky components that make it difficult for users to transport in their pockets or purses, or store in a glove compartment.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates an internal view of an embodiment with the retractable handle released;

FIG. 2 illustrates a top side view of a motor in relation to a side view of a rotor and connected elements;

FIG. 3 illustrates a front view of an embodiment with an outer case;

FIG. 4 illustrates a side view of an embodiment with an outer case;

FIG. 5 illustrates a top view of an embodiment with an outer case; and

FIG. 6 illustrates an internal view of an embodiment with the retractable handle retracted.

### DETAILED DESCRIPTION

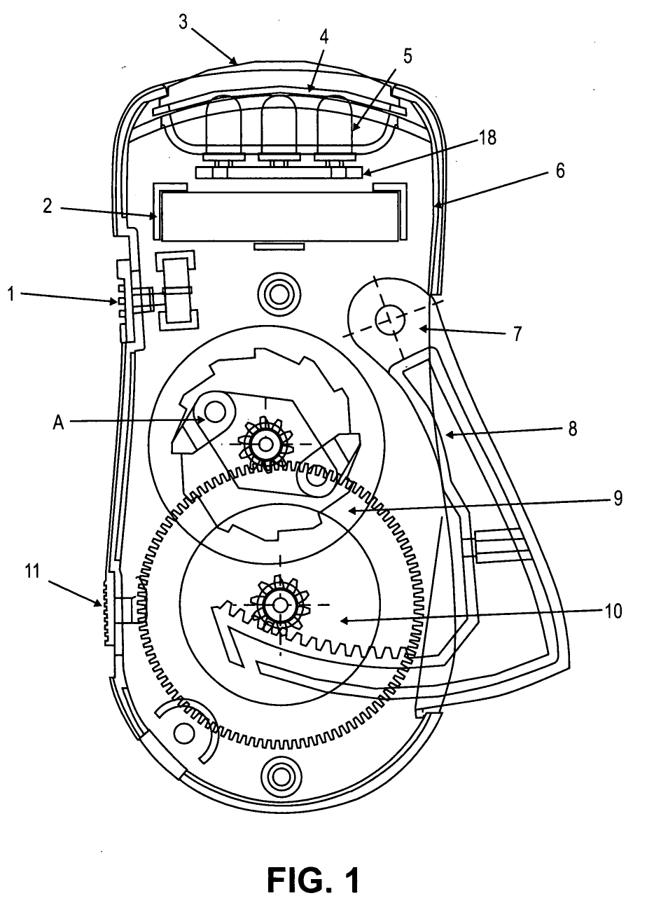

FIG. 1 illustrates an internal view of an embodiment with the retractable handle/lever 7 released. Reference A shows the direction of view. With respect to the type of light in this trigger pressing flashlight, the LED 5 is preferably an LED that has a high luminous intensity. Manufacturers of ISID's grade the LED according to its quality. The highest quality LED's are given and “E” grade. The next highest quality is a “D” grade. LED's with a “D” grade can be equipped with a lens to approximate the quality of an “E” grade. LED's of this quality were initially used in medical applications and are sometimes referred to as having a medical grade application. Although the flashlight of the present invention can be used with any conventional LED, in a preferred embodiment the light source is an “E” grade LED or “D” grade LED. Such a high intensity LED may, for example, be obtained from Hiyoshi Electric Co. Ltd., located in Tokyo, Japan, having Part No. E1 L533BL. The high intensity LED herein described has from three to five times the luminous intensity of a conventional LED. The LED 5 preferably emits blue light, although the present invention can be used with any color LED. Blue light helps to preserve the user's night vision compared with conventional flashlights emitting white light. For other applications blue-green LED's 5 can be used, for example, in situations where compatibility with night vision equipment is desired. Other colored LED's 5 can also be used. Red LED's 5 can be used in applications where the preservation of night vision is desired or for use with pilots or photographers, and even infrared LED's can be used where certain signaling capabilities are required or for use with equipment that senses infrared light. The LED 5 includes first and second leads extending from a connector end of the LED 5 and connected to LED board 18. The LED leads may be provided with extensions that can be soldered onto the leads of the LED.

Over the LEDs 5 is LED reflector shade 4 to reflect light of LEDs 5 forward. Covering the LEDs 5 is a transparent lampshade 3. In one embodiment, more than one LED are included in the rechargeable flashlight (e.g., 3, 4, 5, 6, etc.).

The power source can be a rechargeable battery 2 having sufficient power to energize the LED 5. The battery power source is preferably round and has oppositely disposed generally flat ends. Ni-M1-1, Ni-Cad, or Lithium batteries are preferably used to provide for longer life. To maintain long lasting battery life a spring loaded switch 11 in the side of the cover controls retractable lever 7 which, when pumped, activates a series of gears (gear on handle, gear 10 and small gear coupled with gear 10 on motor/dynamo 9) and attached to a dynamo 9 developing 1650 rpm. At 1650 rpm the dynamo 9 produces an output voltage of 3.00 volts. Output current is 5.5 MA with an output power of 0.013 watts.

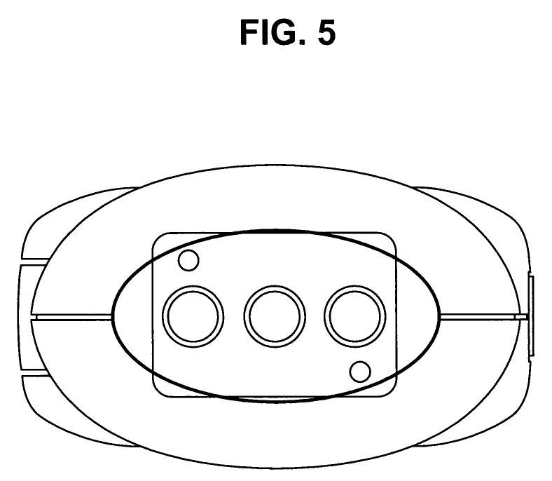

The power source frame (i.e., casing) may be made of nonconductive plastic and preferably has generally flat oppositely disposed first and second sides (see FIG. 4, first outer casing 41 and second outer casing 42). The power source frame can be adapted to receive and house a power source, and includes a power source cavity for this purpose. The power source frame also includes a receptacle at the front end to receive and house a connector end of an LED 5. The leads of the LED 5 are preferably positioned so that one lead extends over the first side of the power source and another lead extends over the second side of the power source. The power source frame protects and secures the internal components of the flashlight. The power source frame also provides resistance to shock and safeguards the light source and power source within the frame. The power source frame may include a power source cavity cover that serves to further enclose the power source.

A switch element 1 is preferably located on the side opposite the power source cavity. The side of the power frame opposite the side having the power source cavity may include a retractable spring loaded handle 7 having a terminus in the power source frame that houses the switch element 1. The switch element 1 is preferably a slide type switch that is located between one of the leads of the LED 5 and the power source 2 but out of contact with the power-source 2. The switch 1 is referred to as a slide-switch. Applying a horizontal pressure to move the switch 1 forward or backward activates the switch 1, thereby completing a circuit that includes the leads of the LED 5 and the power source 2. Once contact between the switch 1 and the LED 5 is broken the flashlight remains in its normal “off” position. Thus, the switching arrangement reduces the wear on the leads of the LED 5 and increases the overall reliability.

The rechargeable battery 2 and gear driven dynamo 9 provide suitable weight and balance to make for the appearance of a heavier flashlight, yet is light in comparison. In addition, the weight provides the flashlight with greater substance and as a result a higher perceived value in the hands of the user. With the added weight the flashlight appears more substantial, considerably more solid and denotes the appearance of a higher quality than a lightweight flashlight. FIG. 1, reference 8, denotes the retractable lever, with gear teeth (located on the inside, middle of the device) that articulates with the big gear to provide force & subsequently energy for the motor to turn.

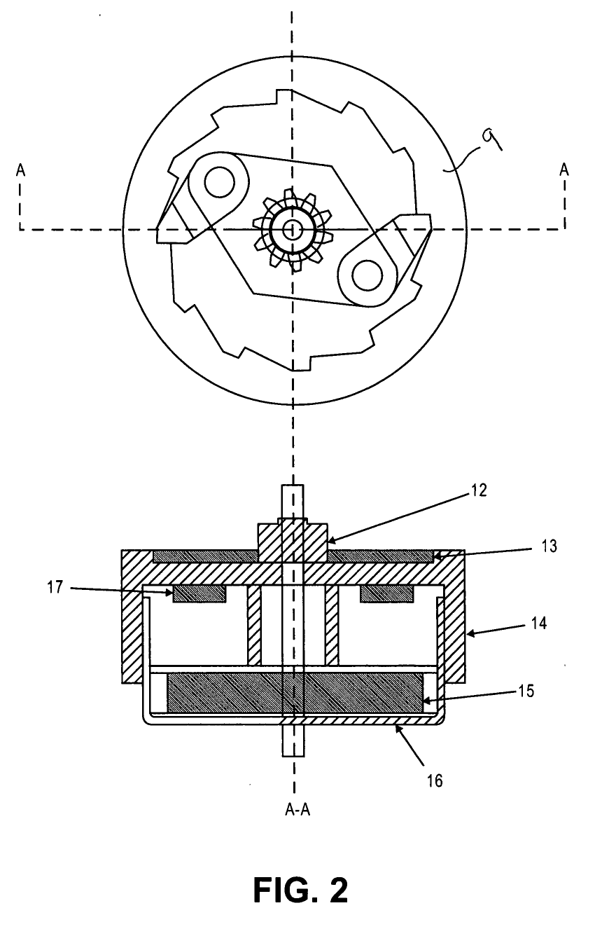

FIG. 2 illustrates a top side view of a dynamo/motor 9 in relation to a side view of a rotor gear apart 12. Reference 13 is the foot of the rotor while reference 14 is the crust of the rotor. A gasket 16 covers the winding mechanism 15. Reference point 17 is the magnet that assists in the winding function for the motor. The best features of this trigger pressing flashlight are ease of use, durability and dependability. Squeezing the retractable handle 7 after use provides for maintenance of extended hours of flashlight operation. Extreme temperatures do not affect the flashlight and it will operate easily in a temperature range between −40° F. to 140° F. This makes the flashlight, again when combined with the rechargeable battery 2 and the retractable handle 7, unique and extremely useful to law enforcement and the general public alike.

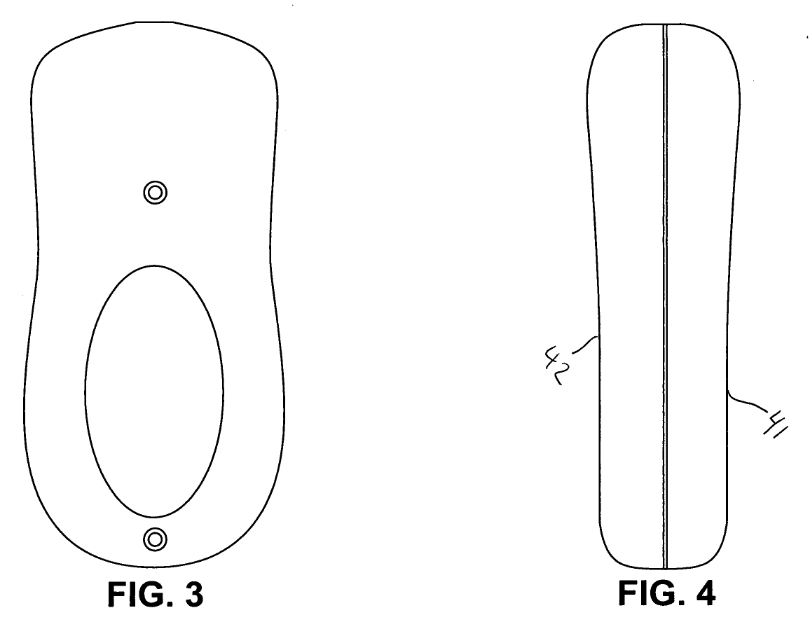

FIG. 3 illustrates a front side view of the rechargeable flashlight with key rings for connecting the rechargeable flashlight to a key ring. As illustrated in FIG. 4, the power source frame housing is preferably of a two-piece construction with each piece disposed on either side of the power source frame. The power source frame housing includes a first housing side 41 disposed about the first side of the power source frame and a second housing side 42 disposed about the second side of the power source frame, the two sides conforming to the periphery of the power source frame. The housing is preferably constructed of plastic. In one embodiment the entire housing may be colored to match the color of the LED 5. For example, a red housing may be used with a red LED, a blue housing with a blue LED, etc. It is often desirable to engrave or imprint the side covers with surface indicia. For example, a company logo or name of a product could be located on either of the side covers. The use of engraving or printing on the side covers can be used for promotional or advertising purposes. In addition, a flashlight bearing certain markings on the side covers could serve as a prose or be used to commemorate an important event.

The side covers provide additional protection to the internal components of the flashlight. The sturdy plastic construction serves to guard the light source and the power source from external forces. Side covers of varying colors may be used to assemble flashlights of varying contrasting colors. For example, flashlights having side covers bearing corporate colors can be easily assembled. Flashlights having side covers bearing the colors of a favorite team can be provided. For example, a flashlight having a green side cover on one side and a yellow side cover on the other side could be used to represent the colors of a sports team, such as the Green Bay Packers®. In addition, a Green Bay Packers® logo or any logo could be included on one side or both side covers of the flashlight due to the fact that it is made of sturdy plastic.

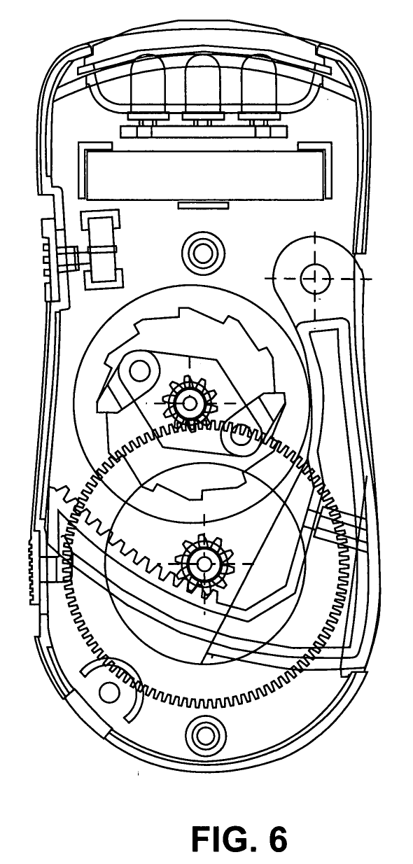

FIG. 5 illustrates a top view of the rechargeable flashlight. FIG. 6 simply illustrates the embodiment illustrated in FIG. 1 with the retractable handle 7 in a retracted state. As illustrated, when the retractable handle 7 is in the retracted state, the retractable handle 7 is flush with the power source frame.

The flashlight of the present invention is small, compact and easy to operate. The flashlight may be easily carried in the pocket, or on the clothing or it can be stored in glove compartments or in any drawer in a house. The flashlight may also be quickly and easily retrieved and operated utilizing the retractable handle to recharge the battery and emit a light.

In the foregoing specification, specific embodiments are described. However, various modifications and changes may be made thereto without departing from the broader spirit and scope of embodiments as set forth in the claims. The specification and drawings are, accordingly, to be regarded in an illustrative rather than a restrictive sense.

What is claimed is:

1. A rechargeable flashlight comprising:
a plurality of gears;
a dynamo coupled to the plurality of gears;
a retractable handle coupled to one of the plurality of gears;
a rechargeable battery coupled to the dynamo;
a plurality of light emitting diodes (LEDs) coupled to the rechargeable battery;
a first switch coupled to the retractable handle; and
a second switch coupled to the rechargeable battery.

2. The rechargeable flashlight of claim 1, wherein the first switch one of locks the retractable handle and releases the retractable handle, and the first switch is spring loaded.

3. The rechargeable flashlight of claim 1, wherein the second switch one of couples the rechargeable battery to the plurality of LEDs and decouples the rechargeable battery from the plurality of LEDs.

4. The rechargeable flashlight of claim 1, wherein pumping of the retractable handle charges the rechargeable battery.

5. The rechargeable flashlight of claim 1, further comprising:
a housing;
a lampshade coupled to the housing;
wherein the lampshade protects the plurality of LEDs.

6. The rechargeable flashlight of claim 1, wherein the plurality of LEDs are capable of being powered on during charging of the rechargeable battery.

7. The rechargeable flashlight of claim 1, wherein the retractable handle is flush with a housing when retracted and locked.

8. The rechargeable flashlight of claim 7, wherein the housing comprising a first housing cover and a second housing cover.

9. The rechargeable flashlight of claim 1, wherein the plurality of LEDs are one of clear and colored.

10. A flashlight comprising:
a dynamo;
a pump device coupled to the dynamo;
at least one rechargeable battery coupled to the dynamo; and
a plurality of light emitting diodes (LEDs) coupled to the at least one rechargeable battery.

11. The flashlight of claim 10, further comprising:
a first switch coupled to the at least one rechargeable battery; and
a second switch coupled to the pump device,
wherein one of locks the pump device and releases the pump device, and the second switch is spring loaded.

12. The flashlight of claim 10, wherein the first switch controls the plurality of LEDs.

13. The flashlight of claim 10, wherein pumping of the pump device charges the at least one rechargeable battery.

14. The flashlight of claim 10, further comprising:
a first housing cover and a second housing cover; and
a lampshade, the lampshade covers the plurality of LEDs.

15. The flashlight of claim 10, wherein the plurality of LEDs are capable of being powered on during charging of the at least one rechargeable battery.

16. The flashlight of claim 10, wherein the pump device is flush with the first housing cover and the second housing cover when retracted and locked.

17. The flashlight of claim 10, wherein the plurality of LEDs are one of clear and colored.

18. A system comprising:
a flashlight housing;
a pump-activated motor disposed in the housing;
a pump device coupled to the pump-activated motor;
at least one rechargeable battery coupled to the pump-activated motor; and
at least one light emitting diode (LED) coupled to the at least one rechargeable battery,
wherein pumping the pump device charges the at least one rechargeable battery.

19. The system of claim 18, further comprising:
a first switch coupled to the pump device; and
a second switch coupled to the at least one rechargeable battery,
wherein the first switch one of locks the pump device and releases the pump device, the first switch being spring loaded, and the second switch controls the at least one LED.

20. The system of claim 18, wherein the at least one LED is capable of being lighted during charging of the at least one rechargeable battery.

21. The system of claim 18, wherein the pump device is flush with the housing when retracted and locked.
